(19) United States
(12) Patent Application Publication
(10) Pub. No.: US 2019/0030658 A1
(43) Pub. Date: Jan. 31, 2019

(54) METHOD FOR MANUFACTURING A VALVE

(71) Applicant: Mahle International GmbH, Stuttgart (DE)

(72) Inventors: Roberto Cutrona, Backnang (DE); Pedro M. Lerman, Rafaela (AR); Christoph Luven, Stuttgart (DE); Alexander Puck, Esslingen (DE)

(21) Appl. No.: 16/046,215

(22) Filed: Jul. 26, 2018

(30) Foreign Application Priority Data
Jul. 26, 2017 (DE) 102017212885.2

(51) Int. Cl. B23P 15/00; B23K 13/01; B23K 20/12; F16K 27/02

(52) U.S. Cl. CPC B23P 15/001; F16K 27/02; B23K 20/12; B23K 13/015

(57) ABSTRACT

A method for manufacturing a valve may include welding two components to each other via a combined induction/friction welding process. One of the two components may be a valve head and the other of the two components may be a valve stem.

### CROSS-REFERENCE TO RELATED APPLICATIONS

This application claims priority to German Patent Application No. DE 10 2017 212 885.2, filed on Jul. 26, 2017, the contents of which are hereby incorporated by reference in its entirety.

### TECHNICAL FIELD

The present invention relates to a method for manufacturing a valve. The invention also relates to a valve manufactured according to this method.

### BACKGROUND

When valve stems with associated valve heads are welded, typically a friction welding process is used, but this can lead to undesirable weld beads which require post-processing and may prevent movement of the sodium-containing coolant present in the hollow space. There are several variations of friction welding processes, but all of them rely on the same principle, specifically sliding friction is used to convert kinetic energy (typically rotational motion) into heat. At no time during the process is any of the metals melted, which is why this process falls within the category known as solid-state welding. Since none of the materials involved is melted, these welding processes are not vulnerable to defects associated with fusion welding, such as porosity, slag inclusions, incomplete fusion, inadequate penetration, undercutting, etc.

DE 699 20 770 T2 discloses a solid-state welding process for pipelines in which the respective advantages of induction welding and friction welding are combined.

A process for welding two piston parts for example is known from U.S. Pat. No. 7,005,620 B2.

### SUMMARY

The present invention deals with the problem of providing an improved or at least an alternative embodiment of a valve manufacturing method for a valve of the species-related type which in particular overcomes the known drawbacks of the related art.

This problem is solved according to the subject matter of the independent claim(s). Advantageous variants are the subject matter of the dependent claim(s).

The present invention is based on the general idea of utilising a combined induction/friction welding process for the first time in a method for manufacturing a valve, particularly a hollow valve or a solid valve, with at least two metal components in the form of the valve stem and a valve head arranged on the longitudinal end thereof in order to connect the metal components of the hollow valve with each other. By this means, particularly the weld beads which typically occur with friction welding can be avoided, thus enabling improved cooling of the valve head, since a movement of the sodium-containing coolant present in the hollow space is no longer obstructed by the internal weld beads. In addition, with a method according to the invention the welded joint may also be shifted towards the valve head, and consequently less of the higher alloyed material typically used there is needed, (cost saving). The combined induction/friction welding process according to the invention further offers the great advantage that the choice of materials for working is less limited than with laser welding.

In the following text, for the sake of simplicity reference will be made consistently to components of the valve, although it is understood that this description refers to the valve head and the valve stem.

In an advantageous further development of the invention, the combined Induction/friction welding process comprises the steps described in German document DE 699 20 770 T2:
heating opposing, particularly parallel surfaces of the components (valve head and valve stem) by means of an induction heating system, particularly by means of a high-frequency induction heating system, to a first temperature which is generally higher than the recrystallisation point of the components in a non-oxidising atmosphere, in particular by arranging the induction heating system between the opposing surfaces,
continuously moving at least one component relative to the other component parallel to the opposing flat and parallel surfaces,
bringing the opposing surfaces of the components that are to be joined together with an axial force while continuing to move at least one of the components in order to weld the opposing surfaces of the components together, wherein at least about 90% of the welding energy is contributed by the induction heating system, and the equalising welding energy is contributed by conventional friction welding, and wherein a total length loss of the components due to squeezing is less than 1.0 axial millimetre per millimetre of the wall thickness of the components.

The method according to the invention thus includes rapid heating of the opposing surfaces of the components with an induction heating system and also a continuous movement of at least one of the components relative to the other component parallel to the opposing planar surfaces, for example by rotating one of the components. Finally, the method described in DE 699 20 770 T2, which is applied for the manufacture of valves for the first time here comprises brining the opposing component surfaces together rapidly with an axial force that is significantly lower than the compression force used in conventional friction welding, while the one component continues to be moved relative to the other component in order to carry out solid-state welding of the opposing component surfaces.

In an advantageous further development of the method according to the invention, said method comprises heating the opposing surfaces of the components to be welded to the hot working temperature in less than 30 seconds using an induction heater, to limit heating of the component to the first 1.5 mm or less of the opposing surfaces of the components to be welded. The frequency of the induction heating system is preferably 3 kHz or more, more preferably 25 kHz or more.

In the preferred solid-state welding process of this invention, the components can be welded together in about one second after heating, wherein the axial force is maintained for about another five seconds. Accordingly, the solid-state welding of this invention is faster and considerably more efficient than friction welding or induction heating, and produces repeatable welded joints of high integrity at very low rotating speeds.

In a further preferred embodiment of the invention, the heating and welding steps are carried out in a non-oxidising atmosphere by flooding the components with a non-oxidising gas such as nitrogen, which improves the resulting welded joint significantly.

As was explained earlier, the improved solid-state welding process according to the invention produces a better welded joint with significantly reduced flash losses. When tubular components are welded together by conventional friction welding, the large, internal flash which is produced by conventional friction welding may also inhibit the flow of fluids, in this case specifically the flow of sodium. Therefore, this invention also comprises a valve with one component embodied as a valve head and one component embodied as a valve stem, with opposing planar surfaces which are welded together with a relatively small planar flash that extends radially from the contact plane of the opposing planar welded surfaces. The flash loss corresponds to a combined loss of length of less than 1.0 axial millimetre per mm of wall thickness.

The method of this invention preferably also comprises enclosing the weld area and introducing a shield gas around the surfaces. As was noted previously, the heating and welding steps are preferably carried out in a non-reactive atmosphere to avoid a chemical reaction between the heated joint surfaces and any of the gases which are normally present in the Earth's atmosphere: oxygen, nitrogen, carbon dioxide, steam etc. For example, steel bonds readily with oxygen at elevated temperatures to yield oxides that cause defects in the welded joint. Conversely, nitrogen only reacts weakly with steel, and is therefore a very useful shield gas. Of course, other shield gases such as argon or helium are also conceivable.

Alternatively, harmful gases in the atmosphere may be excluded for all metal types by conducting this solid-state welding process in a vacuum. For particular metals, harmful gases may be excluded by coating the opposing surfaces beforehand with a very thin film of a metallurgically compatible solid barrier substance which will also not react with the normal components in the Earth's atmosphere.

Although the most logical choice of a shield gas is argon, experiments have shown that argon causes flashovers close to the end of the heating cycle, which can be avoided by using nitrogen.

If the temperature of metals is raised, the mechanical properties of the metals gradually become less elastic (and brittle) and more plastic (and resilient) until the melting point is reached, at which all mechanical strength is lost. Resistance to deformation also diminishes with rising temperatures. A material-specific temperature is generally referred to as the hot working temperature (THW), which is generally defined as a temperature above the recrystallisation point or as a temperature which is high enough to avoid work hardening. It is assumed that the THW for a given metal is any temperature between about 50% and 90% of the melting temperature, expressed in absolute terms (i.e. Kelvin or degrees Rankine). Conventional friction welding uses mechanical friction to increase the temperature of two adjacent components to THW, wherein the sliding movement can cause a controlled degree of bonding between the two components, resulting in a strong welded joint. The solid-state welding process of this invention uses induction heating to raise the joining surfaces of the components to the hot working temperature.

The method of this invention may be conducted on the basis of any type of friction welding including flywheel, continuous, orbital and oscillating friction welding.

Further important features and advantages of the invention will be evident from the subordinate claims, the drawings and the associated description of the figures with reference to the drawings.

It is understood that the features explained in the preceding text as well as those which will be explained later are usable not only in the combinations described, but also in other combinations or alone without departing from the scope of the present invention.

Preferred embodiments of the invention are represented in the drawings and will be explained in greater detail in the following description, wherein identical or similar or functionally equivalent components are designated with the same reference signs.

### BRIEF DESCRIPTION OF THE DRAWINGS

In the schematic drawings,

FIG. 1A shows a partial longitudinal cross section through a valve that has been welded according to a conventional friction welding process,

FIG. 1B shows a partial lateral cross sectional view of a valve that has been welded according to the solid-state welding process of the invention,

FIG. 1C shows a partial longitudinal cross section of a second variant of a valve that has been welded according to the solid-state welding process of the invention,

FIG. 2A shows a longitudinal cross section of an area of the device for the solid-state welding process,

FIG. 2B shows a cross section along sectional plane B-B,

FIG. 3 shows a valve that has been welded with the method according to the invention.

### DETAILED DESCRIPTION

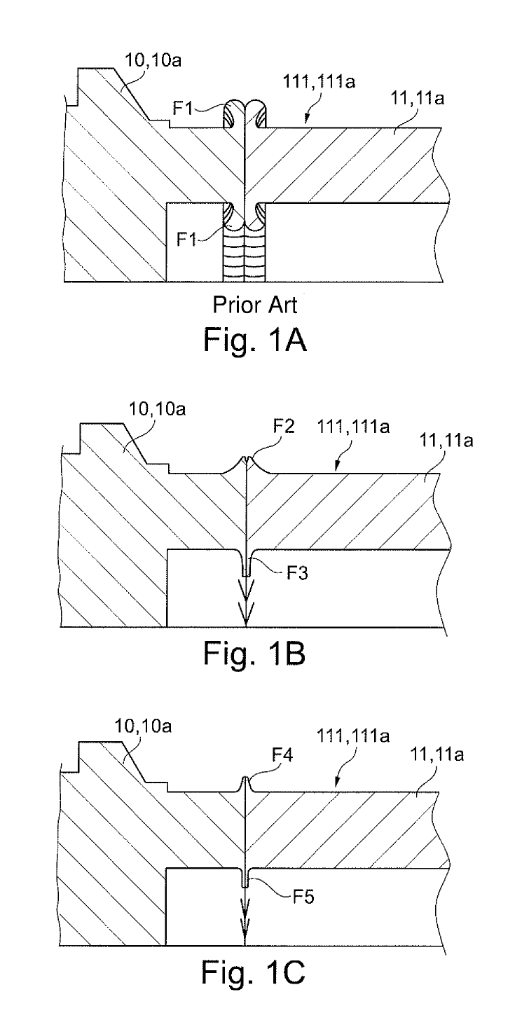

FIG. 1A illustrates a welded valve 111, which in the case shown for example is in the form of a hollow valve but may also be a solid valve, and which has been manufactured according to conventional friction welding techniques, for example conventional flywheel welding. Valve 111 has a component 10 constructed as a valve head 10a and a component 11 constructed as a valve stem 11a, which are welded to each other by friction welding, by rotating one of the components 10, 11 relative to the other component 11, 10 while simultaneously pressing the two components together. In friction welding, the opposing surfaces heat up to the hot working temperature. The greatest problem with such friction welded joints is the excess flash material which forms on the insides and outsides of the welded joint and looks like a double torus.

Particularly in the case of hollow valves 111a, the internal flash detail F1 must be removed, or at least kept very small, which involves additional effort and/or can impair the notch effect and obstruct the flow of the coolant present in hollow valve 111a. Moreover, as described previously the large volume of flash results in a weaker welded joint due to concentrations of non-metal inclusions from the loss of length in the weld interface. The solid-state welding process according to the invention therefore not only reduces the loss of material and length during the welding cycle, it also improves structural integrity.

FIGS. 1B and 1C represent the characteristic profiles of welded joints that are produced in the method according to the invention.

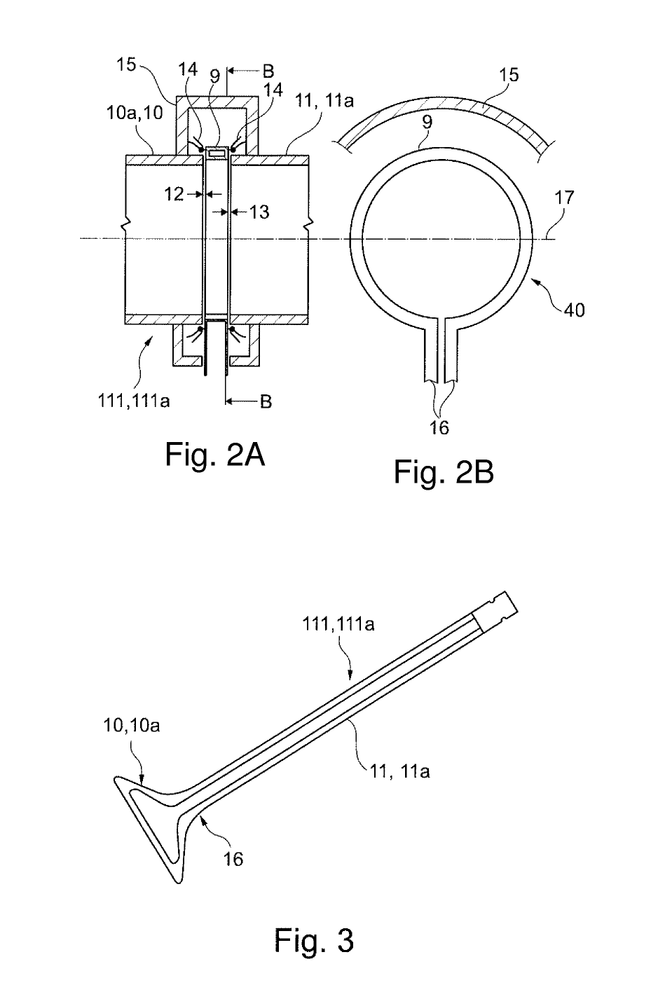

FIG. 1C shows an induction coil 9 (see FIG. 2) of appropriate dimensions resulting in a fully bonded external flash F4. The total quantity of flash material, F4 and F5 can also be reduced. The flash volume and length loss were significantly reduced in both of the embodiments represented in FIGS. 1B and 1C, and the integrity of the welded joint was improved.

The combined induction/friction welding process according to the invention comprises the following steps:
heating opposing, particularly parallel surfaces of the components 10,11 by means of an induction heating system 40 to a first temperature, which is in particular above the recrystallisation point of components 10,11 in a non-oxidising atmosphere by arranging the induction heating system 40 between the opposing surfaces or externally,
continually moving at least one component 10,11 relative to the other component 11,10 parallel to the opposing surfaces,
bringing together the opposing surfaces of the components 10, 11 to be joined with an axial force while at least one of the components 10,11 is still being moved in order to weld the opposing surfaces of the components 10,11 to each other, wherein a part of the welding energy, preferably at least about 90%, is contributed by the induction heating system 40 and the equalisation welding energy is contributed by conventional friction welding, and wherein a total length loss of components 10,11 is less than 1.0 axial millimetre per millimetre of the wall thickness of the components 10,11.

A particular advantage in the production method according to the invention is that only a fraction of the axial length is used, so that a much smaller volume of welded joint flash is generated. Unlike the previous friction welding process, the welding method according to the invention actually starts before the two components to be joined come into contact with one another. The induction heating phase, which supplies most of the necessary welding energy, runs synchronously with the acceleration of the rotating component 10, 11 and is completed a few tenths of a second before the two components 10, 11 come into contact. This is necessary to ensure that there is time to retract the induction coil 9 between the components 10, 11 and subsequently close the axial gap for contact.

In the example of joining two components 10, 11 which are designed with clean, smooth, straight cut parallel ends, the induction coil 9 may be arranged between the opposing longitudinal ends of the two components 10 and 11, which leaves a small gap 12 and 13 on either side. Normally, the induction coil 9 is a coil with a simple winding formed by a hollow, rectangular copper pipe to enable cooling water to circulate through it during the induction heating cycle. The induction coil 9 is connected to a high-frequency energy supply either via flexible energy supply cables or alternatively via rotating or sliding connections. The size of gap 12 and 13 is normally adjusted to the minimum possible value before the start of the physical contact and/or before the flashover between induction coil 9 and one of the components 10 and 11, either during the heating phase or during the withdrawal. If the two components 10 and 11 have the same diameter, wall thickness and metallurgy, induction coil 9 is arranged equidistantly between the opposing ends of components 10, 11. Alternatively, it is also conceivable to dispose the induction heating system externally. In applications in which one or more of these three parameters are different for the two components 10, 11 of valve 111, the heat supply to the two components 10, 11 is equalised by moving the induction coil 9 closer to the component 10 or 11 which requires the supply of extra heat. The primary objective of adjusting the gap is to ensure that both components 10, 11 reach their respective hot working temperatures at the same time. Gap 12, 13 may be determined and adjusted either before the start of the induction heating phase, or alternatively continuously throughout the induction heating by means of a contactless temperature sensor.

Gaps 12 and 13 serve two purposes. Firstly, they prevent physical contact between the induction coils 9 and one of the components 10 and 11, which would result in contamination of the component surface and an electrical short-circuit of the induction coil 9. They also provide a path of the flow of a shield gas 14 which prevents undesirable oxidation of the heated ends of components 10 and 11. Although nitrogen is preferred in many applications for the reason given previously, the shield gas may be nitrogen, carbon dioxide, argon or other non-oxidising gases or mixtures thereof, selected according to metallurgical requirements availability in the workshop. The gas is surrounded on the outside by a flexible curtain 15 which lies closely against the outer periphery of each component 10 and 11, so that gas 14 is forced to flow radially inwards, and thus continually displaces any oxygen away from the exposed components. It is also provided to allow the induction coil 9 to be withdrawn while the flexible curtain 15 is held in position.

The selection of a suitable shield gas 14 depends mainly on the metallurgy of components 10, 11 and the high temperature ionisation properties of gas 14. For most applications involving ferrous compounds and nickel-based alloys, nitrogen is sufficient. However, a different gas may be necessary for certain metallurgies, e.g., for titanium compounds. Although it is preferred to use a suitable shield gas 14, it should be recognised that the components 10, 11 can be protected from harmful gases by alternative and additional methods such as pre-coating. For this purpose, the opposing surfaces of the components 10, 11 may be pre-coated directly with protective barrier substance, for example a chloride-based flux or the like, which preferably excludes hydrogen.

Finally, FIG. 3 shows a valve 111, 111a which has been produced in the method according to the invention, with a component 10 embodied as valve head 10a and a component 11 embodied as valve stem 11a.

The method according to the invention (“spinduction”) may be used in particular to produce bimetallic valves with important advantages: One key advantage is the avoidance of the interior “hollow-on-hollow” friction weld bead which is left after the usual friction welding and inhibits sodium movement, and would thus impair the thermal management and cooling of hollow valve 111a. If the friction weld seam is eliminated or at least minimised, the coolant is able to flow without obstruction and function to transport heat away from valve head 10a and towards valve stem 11a. The method according to the invention also enables the friction weld seam 16 to be shifted towards valve head 10a, so that less of the usually higher alloyed material is used there (cost saving). A further advantage is the potentially shorter duration of material consumption, which also results in a smaller quantity consumed.

1. A method for manufacturing a valve comprising welding two components to each other via a combined induction/friction welding process, wherein one of the two components is a valve head and the other of the two components is a valve stem.

2. The method according to claim 1, wherein welding the two components to each other via the combined induction/friction welding process includes:
arranging an induction heating system between opposing parallel surfaces of the two components;
heating the opposing surfaces of the two components via the induction heating system to a first temperature above a recrystallisation point of the two components in a non-oxidising atmosphere;
continually moving at least one component of the two components relative to the other component parallelly to the opposing surfaces of the two components;
welding the opposing surfaces of the two components via bringing together the opposing surfaces of the two components with an axial force while the at least one component is continually moving such that at least approximately 90% of a welding energy is contributed via the induction heating system and an equalisation welding energy is contributed via conventional friction welding, and wherein a total length loss of the two components is less than 1.0 axial millimetre per millimetre of wall thickness of the two components.

3. The method according to claim 2, wherein heating the opposing surfaces of the two components includes heating the opposing surfaces of the two components to the first temperature in less than approximately 30 seconds.

4. The method according to claim 2, wherein welding the opposing surfaces of the two components includes i) welding the opposing surfaces of the two components together in approximately one second after heating the opposing surfaces of the two components, and ii) maintaining the axial force for approximately five seconds thereafter.

5. The method according to claim 4, further comprising rotating at least one of the two components, and wherein welding the opposing surfaces of the two components includes welding the opposing surfaces of the two components together in less than approximately four revolutions of the at least one rotating component after heating the opposing surfaces of the two components and maintaining the axial force until a temperature of the opposing surfaces of the two components is below the first temperature.

6. The method according to claim 2, wherein heating the opposing surfaces of the two components includes induction heating the opposing surfaces of the two components to the first temperature in less than approximately ten seconds.

7. The method according to claim 2, wherein heating the opposing surfaces of the two components includes heating the opposing surfaces of the two components via the induction heating system at a frequency of approximately 10 kiloHertz or more.

8. The method according to claim 2, further comprising passing a non-oxidising gas over the opposing surfaces of the two components while heating the opposing surfaces of the two components to the first temperature via the induction heating system.

9. The method according to claim 2, further comprising holding the opposing surfaces of the two components substantially in a vacuum.

10. The method according to claim 9, wherein heating the opposing surfaces of the two components includes heating the opposing surfaces of the two components to the first temperature while holding the opposing surfaces of the two components substantially in the vacuum via the induction heating system.

11. The method according to claim 2, further comprising pre-coating the opposing surfaces of the two components with less than 0.025 mm of a metallurgically compatible material while heating the opposing surfaces of the two components to the first temperature via the induction heating system.

12. The method according to claim 2, wherein continually moving the at least one component includes continually moving the at least one component in a rotary movement.

13. A valve comprising at least two metal components welded together via a combined induction/friction welding process, wherein one of the at least two components is structured as a valve stem and the other of the at least two components is structured as a valve head.

14. The method according to claim 2, wherein:
heating the opposing surfaces of the two components includes heating the opposing surfaces of the two components to the first temperature in less than approximately 30 seconds; and
welding the opposing surfaces of the two components includes:
welding the opposing surfaces of the two components together in approximately one second after heating the opposing surfaces of the two components; and
maintaining the axial force for approximately five seconds after welding the opposing surfaces of the two components.

15. The method according to claim 2, wherein the heating the opposing surfaces of the two components includes heating the opposing surfaces of the two components via the induction heating system at a frequency of approximately 3 kiloHertz or more.

16. The method according to claim 15, wherein the heating the opposing surfaces of the two components includes heating the opposing surfaces of the two components via the induction heating system at a frequency of approximately 25 kiloHertz or more.

17. The method according to claim 8, wherein passing a non-oxidising gas over the opposing surfaces of the two components includes passing a non-oxidising gas including nitrogen gas over the opposing surfaces of the two components.

18. The method according to claim 11, wherein pre-coating the opposing surfaces of the two components includes pre-coating the opposing surfaces of the two components with less than 0.025 mm of pure aluminum, wherein the two components have iron based compositions.

19. The method according to claim 12, wherein welding the opposing surfaces of the two components includes welding the opposing surfaces of the two components together in less than approximately four revolutions of the at least one rotating component after heating the opposing surfaces of the two components and maintaining the axial force until a temperature of the opposing surfaces of the two components is below the first temperature.

20. A method of manufacturing a valve comprising:
arranging an induction heating system between opposing parallel surfaces of two components, wherein one of the components is a hollow valve head and the other of the two components is a hollow valve stem;
producing approximately 90% or more of a welding energy via heating the opposing surfaces of the two components to a first temperature in a non-oxidising atmosphere with the induction heating system, the first temperature being higher than a recrystallisation point of the two components;
producing an equalisation amount of the welding energy via continually, parallelly moving at least one component of the two components while applying an axial force to the two components such that the opposing surfaces of the two components abut each other; and
welding the opposing surfaces of the two components together via the welding energy such that a total length loss of the two components is less than 1.0 axial millimetre per millimetre of wall thickness of the two components.
